(19) United States
(12) Patent Application Publication
(10) Pub. No.: US 2017/0364173 A1
(43) Pub. Date: Dec. 21, 2017

(54) OPTICAL TOUCH SENSOR

(71) Applicant: Peigen Jiang, Sammamish, WA (US)

(72) Inventor: Peigen Jiang, Sammamish, WA (US)

(21) Appl. No.: 15/187,791

(22) Filed: Jun. 21, 2016

(51) Int. Cl. G06F 3/042; G06F 3/041

(52) U.S. Cl. CPC G06F 3/042; G06F 3/0416

(57) ABSTRACT

An optical touch sensor is disclosed which includes a plurality of light emitting bare dies attached directly to a first printed circuit board and placed at a first edge bordering an object surface, the plurality of light emitting bare dies being commonly encapsulated in a first encapsulation having a first reflective surface, and a plurality of light detecting bare dies attached directly to a second printed circuit board and placed at a second edge bordering the object surface across from the first edge, the plurality of light detecting bare dies being encapsulated commonly in a second encapsulation having a second reflective surface, wherein light emitted from the plurality of light emitting bare dies can be detected by the plurality of light detecting bare dies through reflections of the first and the second reflective surface, and wherein a light beam traveling from the first reflective surface to the second reflective surface is above and substantially parallel to the object surface.

### CROSS-REFERENCE

This is a continuation-in-part of U.S. patent application Ser. No. 14/641,373, which was filed on Mar. 7, 2015.

### BACKGROUND

The present invention relates generally to touch sensor, and, more particularly, to an optical touch sensor for computer input devices.

A popular way to position a cursor on a computer display is to use a mouse, which functions by detecting two dimensional motions relative to its supporting surface. Physically, a mouse comprises an object held under one of a user's hands, with one or more buttons. Clicking or hovering (stopping movement while the cursor is within the bounds of an area) can select files, programs or actions from a list of names, or (in graphical interfaces) through small images called “icons” and other elements. For example, a text file might be represented by a picture of a paper notebook, and clicking while the cursor hovers over this icon might cause a text editing program to open the file in a window.

A conventional keyboard can detect a pressing of any key thereof, but cannot detect mere touches on the keys. Here, the “touch” refers to a surface of the keyboard being contacted by an object regardless if the key is pressed or not. If the conventional keyboard is a tactile one, the key pressing results from the key being depressed. If the conventional keyboard is a surface one, such as Touch Cover for Microsoft Surface, the key pressing results from a force being applied on the key. As long as the key remains depressed in tactile keyboard or forced upon in surface keyboard, the key is pressed.

There are significant interests in incorporating mouse functions into a keyboard. One way to do it is to provide a touch tensor to a keyboard to form a combo device that detects touches on a surface of the keyboard, and switching operations of the combo device between a cursor mode and a keyboard mode as programmed. Conventionally the touch sensor employs arrays of light-emitting diodes (LED) to scan the surface of the keyboard with infrared (IR) light. When the scanning light is blocked, a surface touching object is then detected at the blocking location. However, touch sensors employing conventionally packaged LEDs are quite bulky and less accurate.

As such, what is desired is a touch sensor that can accurately detect touch location and are less protrusive.

### BRIEF DESCRIPTION OF THE DRAWING

FIG. 1 is a perspective view of a laptop computer with a keyboard.

FIG. 2 illustrates an infrared-light touch sensing system positioned to detect touch on the keyboard surface.

FIG. 3 illustrates a LED-based touch coordinate detection system.

FIG. 4 illustrates an array of LEDs packaged in the same substrate according to an embodiment of the present invention.

FIG. 5 is a cross-sectional view of a LED package according to an embodiment of present invention.

FIG. 6 is a cross-sectional view of a keyboard with touch sensing using the LED package of the present invention.

FIGS. 7A and 7B are cross-sectional views of a LED package in formation.

FIG. 7C shows a perspective view of the LED package of FIGS. 7A and 7B.

FIG. 8 is a flow-chart illustrating a process of forming the LED package of FIGS. 7A and 7B.

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawings, wherein like reference numbers (if they occur in more than one view) designate the same elements. The invention may be better understood by reference to one or more of these drawings in combination with the description presented herein.

### DESCRIPTION

The present invention relates to an optical touch sensor designed, particularly, for keyboard-and-mouse combo devices to provide cursor input for computers. A preferred embodiment of the present invention will be described hereinafter with reference to the attached drawings.

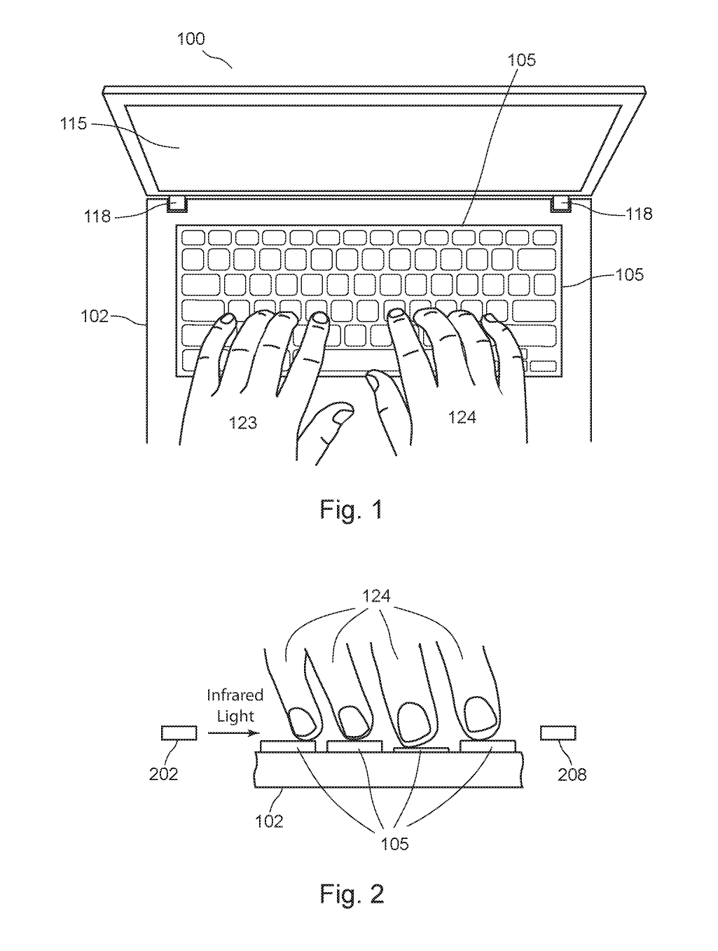

FIG. 1 is a perspective view of a laptop computer 100 with a conventional keyboard 105 for entering text, etc. The laptop computer 100 has a base unit 102 containing the keyboard 105, and a display panel 115 which is hinged to the base unit 102 by hinges 118. A skilled computer user can generally type on the keyboard 105 with both hands 123 and 124. An optical touch sensor can detects whether or not the surface of the keyboard 105 is touched without interfering with regular keyboard operations.

FIG. 2 illustrates an infrared-light touch sensing system positioned to detect touches on the surface of the keyboard 105. The infrared-light touch sensing system includes an infrared light emitter 202 and an infrared light receiver 208. The infrared light travels across the surface of the keyboard 105. A finger 124 or any other object touching the surface of the keyboard 105 blocks the infrared light from being received by the infrared light receiver 208. As a result, the touch can be detected.

Referring back to FIG. 1, the infrared light emitter 202 can be positioned along one edge of the keyboard 105 and the infrared light receiver 208 can be positioned along the opposite edge of the keyboard 105. In order to obtain coordinates of a touch, two sets of the infrared light touch sensors will be needed with one set positioned on the horizontal edges and the other on the vertical edges.

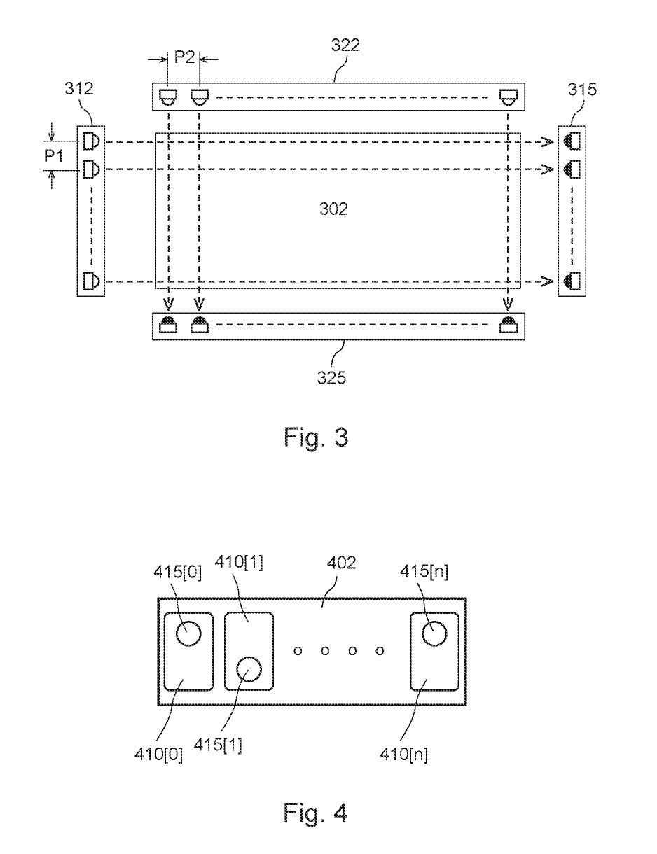

FIG. 3 illustrates a LED-based touch coordinate detection system which comprises a pair of horizontally placed LED arrays 312 and 315 and a pair of vertically placed LED arrays 322 and 325. The LED arrays 312 and 322 controllably emit light, and the LED arrays 315 and 325 correspondingly detects light. If light is blocked at certain detecting LEDs, then coordinates of the blocking object can be extracted from the corresponding LED locations. Pitches P1 and P2 between two adjacent LEDs determine accuracy of the LED touch coordinate detection system, i.e., the smaller the pitches P1 and P2, the more accurate the touch coordinate detection system is.

Conventionally LED dies are individually packaged and then mounted into an array as shown in FIG. 3. Even though individual LED die size can be very small, individually packaged LED is large due to the packaging material. Reduction of the pitches P1 and P2 using conventionally packaged LEDs is limited.

FIG. 4 illustrates an array of LED dies 410[0:n] packaged in the same substrate 402 according to an embodiment of the present invention, where n is an integer. Each die 410[i] has an anode 415[i] on the top and a cathode on the bottom (not shown), where i is an integer between 0 and n. Wire bonding may be used to connect each anode 415 to an external lead (not shown). In order to separate leads more widely, leads of adjacent LED dies 410[0] and 410[1] may be placed on opposite sides of the substrate 402. For instance, if the lead for anode 415[0] is placed on the upper side of the substrate 402, the lead for anode 415[1] is placed on the lower side of the substrate 402 as shown in FIG. 4. The cathodes of all the LED dies 410[0:n] can be commonly connected to a single external lead (not shown). Because the LED dies 410[0:n] are bare dies, pitch between juxtaposing units is mostly limited by the size of the LED dies 410[0:n] themselves. Therefore, a LED array formed in this way can have very fine pitches.

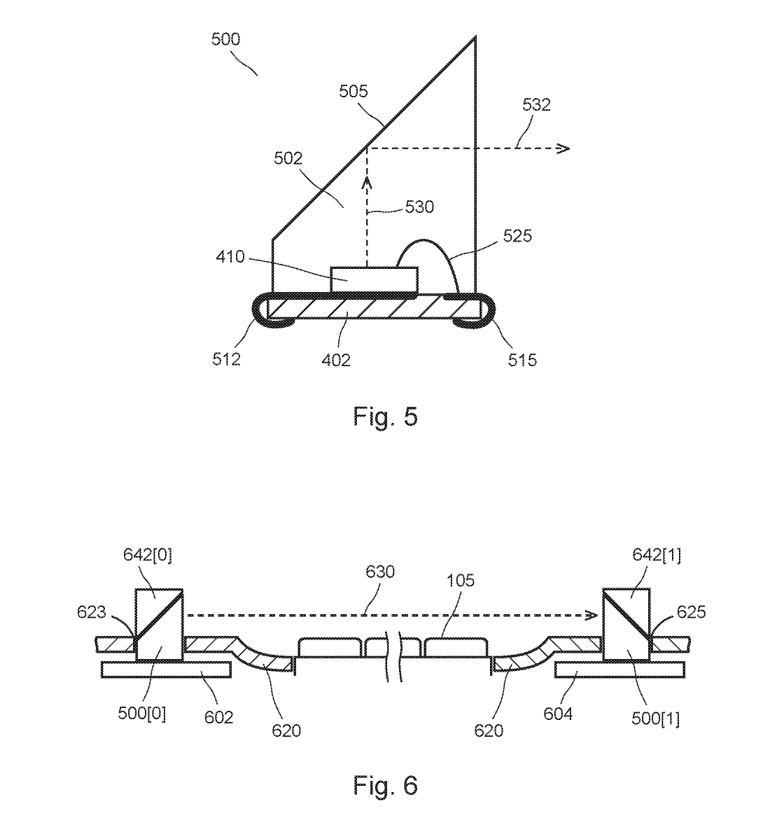

FIG. 5 is a cross-sectional view of a LED package 500 according to an embodiment of present invention. The LED package 500 comprises a LED die 410 horizontally mounted on the surface of a substrate 402, leads 512 and 515, and a plastic shell 502. The lead 512 is connected to a cathode of the LED die 410 at the bottom thereof. The lead 515 is wire bonded an anode of the LED die 410 on the top thereof. The plastic shell 502 is made of a material transparent to infrared, and has a slanted flat surface 505 on the top which is coated with a reflective material for reflecting light emitted from the LED die 410. As shown in FIG. 5, the LED die 410 emits light 530 upwardly and, the slanted flat surface 505 redirects the light 532 to a horizontal direction. In embodiments, the slanted flat surface 505 is angled at 45 degrees to the horizontal surface, so that majority of the reflected light 530 travel in parallel to the horizontal surface. In embodiments, an entire length of a LED array is covered by one piece of the plastic shell 502 which is molded into a desired shape.

Although FIG. 5 shows a light emitting LED package 500, a skilled artisan would recognize that a light detecting LED package can have the same structure as that of the light emitting LED package 500. In some applications, light emitting LED and light detecting LED can be interchangeably used.

FIG. 6 is a cross-sectional view of a keyboard with touch sensing using the LED package 500 shown in FIG. 5. A light emitting LED package 500[0] is mounted on a printed circuit board 602 with a top portion protruding through an opening 623 on a keyboard enclosure 620. A light detecting LED package 500[1] is mounted on another printed circuit board 604 with a top portion protruding through an opening 625 on the other side of the keyboard enclosure 620. Light beam 630 traveling from the LED package 500[0] to the LED package 500[1] is slightly above and substantially parallel to a surface of the keyboard 620.

Referring again to FIG. 6, in order to protect the reflective surface of the LED package 500, an added member 642[0] is attached to a top part of the LED package 500[0], and an added member 642[1] is attached to a top part of the LED package 500[1]. The added members 642 and 644 also ornament the protruding LED packages 500[0:1]. In embodiments, the added members 642[0:1] are molded plastic covering only the slanted reflective surface of the LED packages 500[0:1], respectively, and are conveniently made symmetrical. In other embodiments, the added member 642 is made of a dark material, when being attached to the slanted surface of the LED package 500, the slanted surface becomes reflective.

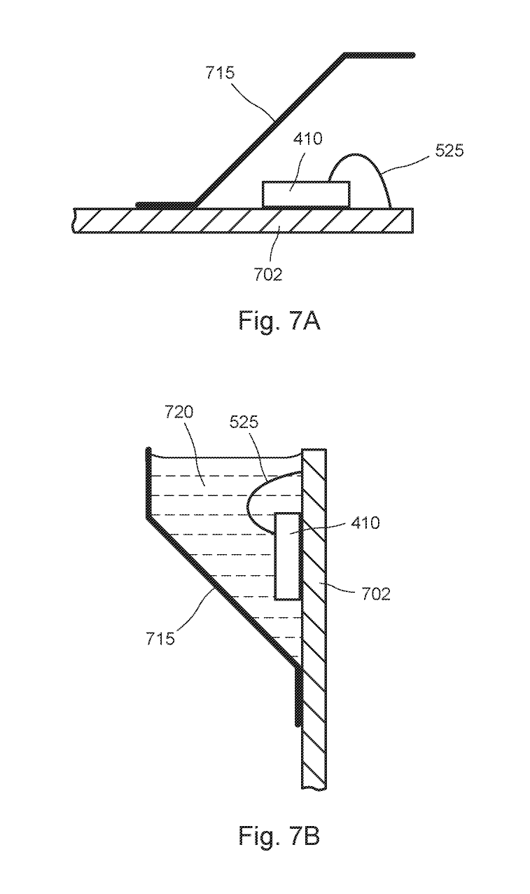

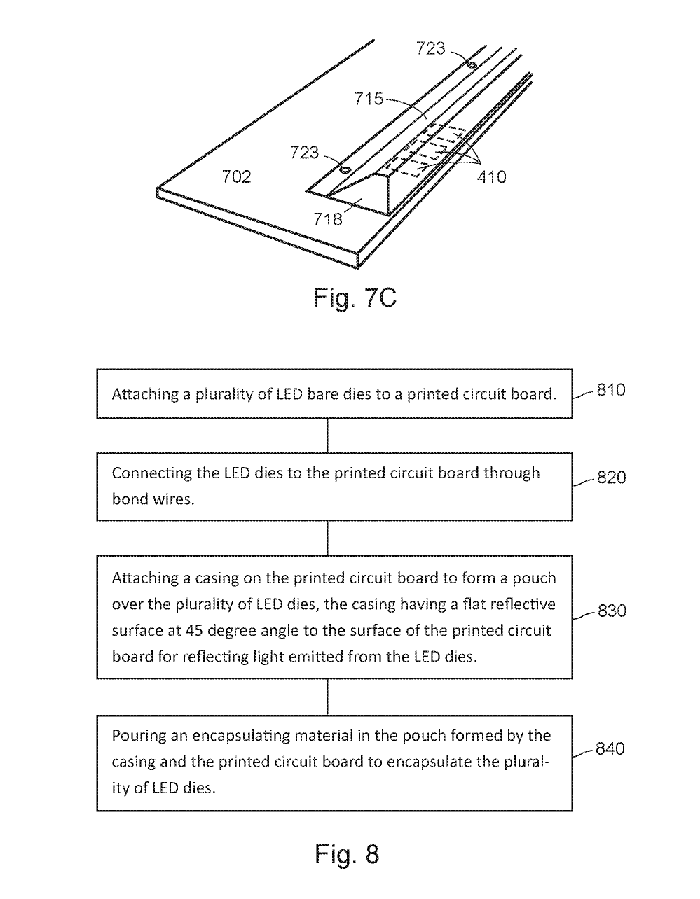

FIGS. 7A and 7B are cross-sectional views of a LED package in formation. Referring to FIG. 7A, a LED bare die 410 is attached directly to a printed circuit board (PCB) 702. The LED die 410 may have two terminals (not shown), one at the bottom and one on the top. The bottom terminal contacts directly to a pad on the PCB 702. The top terminal is connected to another pad on the PCB 702 through a bonding wire 525. After a row of the LED dies 410 are attached and wire bonded to the PCB 702, a casing 715 is attached to the PCB 702. The casing 715 together with the PCB 702 forms a pouch to contain an encapsulation material, such as a high-reliability low-stress epoxy resin, to encapsulate the LED dies 410.

Referring to FIG. 7B, during an encapsulating process, the PCB assembly is kept in a vertical position, so that an encapsulating resin 720 can be injected and settle in the pouch formed by the PCB 702 and the casing 715. In the current application, the encapsulating resin 720 is chosen to be more transparent to infrared light than lights in other wave lengths. In order to reflect light emitted from the LED die 410, interior surface of the casing 715 has a flat reflective surface slanted at 45 degree angle to the surface of the PCB 702. In an embodiment, the casing 715 is made of a polished sheet stainless steel. After the encapsulating resin 720 hardens the casing 715 remains in place to serve as a reflective surface. However, in other embodiments, the casing 715 is removed, a reflective surface is then formed on the surface of the encapsulating resin 720 by attaching a mirror film thereto.

FIG. 7C shows a perspective view of the LED package of FIGS. 7A and 7B. The casing 715 is attached to the PCB 702 covering a row of LED dies 410. The casing 715 has an end cap 718 for containing the encapsulating material 720 during the encapsulating process. In an embodiment, the casing 715 is fastened to the PCB 702 through a plurality of rivets 723. In other embodiments, the casing 715 can be soldered or glued to the PCB 702. FIG. 7C shows only a part of the LED package and some exemplary LED dies 410. A total number of and pitches in-between the LED dies 410 are determined by size and resolution of a touch sensing area the LED package is used for. As the LED bare dies 410 can be as small as 0.2 mm, they can be closely spaced in the LED package, so that a touch sensing device formed by such LED package can have high resolution.

FIG. 8 is a flow-chart illustrating a process of forming the LED package of FIGS. 7A and 7B. The process begins with attaching a plurality of LED bare dies to a printed circuit board in step 810. Electrical connections between the LED dies and the printed circuit board are established in step 820. The electrical connections include wire bonding. In step 830, a casing is attached to the printed circuit board to form a pouch over the plurality of LED dies. The casing has a flat reflective surface at 45 degree angle to surface of the printed circuit board for reflecting light emitted from the LED dies. In step 840, an encapsulating material, such as an infrared transparent epoxy resin, is injected in the pouch formed by the casing and the printed circuit board to encapsulate the plurality of LED dies. During the encapsulating step 840, the printed circuit board may be held vertically so that an opening of the pouch faces upward, and the encapsulating material can settle into the pouch by gravity.

Although the embodiments of the present disclosure use LED dies as an example, the structure and the process depicted in FIGS. 7-8 can also apply to photo detecting diode or photo transistor dies, i.e., the photo detecting diode or photo transistor can take the place of LED. In fact, from a circuit perspective, light emitting and light detecting devices can have the same circuit design and are just applied differently. Such light-emitting and light detecting dies are generally called optical dies.

While this disclosure has been particularly shown and described with references to exemplary embodiments thereof, it shall be understood by those skilled in the art that various changes in form and details may be made therein without departing from the spirit of the claimed embodiments.

What is claimed is:

1. An optical touch sensor comprising:
a plurality of light emitting bare dies attached directly to a first printed circuit board and placed at a first edge bordering an object surface, the plurality of light emitting bare dies being commonly encapsulated in a first encapsulation having a first reflective surface; and
a plurality of light detecting bare dies attached directly to a second printed circuit board and placed at a second edge bordering the object surface across from the first edge, the plurality of light detecting bare dies being commonly encapsulated in a second encapsulation having a second reflective surface,
wherein light emitted from the plurality of light emitting bare dies can be detected by the plurality of light detecting bare dies through reflections of the first and the second reflective surface, and a light beam traveling from the first reflective surface to the second reflective surface is above and substantially parallel to the object surface.

2. The optical touch sensor of claim 1, wherein the plurality of light emitting bare dies and the plurality of light detecting bare dies are placed substantially in parallel with the object surface.

3. The optical touch sensor of claim 1, wherein the first and the second reflective surface are angled at approximately 45 degrees to the object surface.

4. The optical touch sensor of claim 1, wherein the first and the second encapsulation are substantially transparent to infrared light emitted from the plurality of light emitting bare dies.

5. The optical touch sensor of claim 1, wherein the object surface is a surface of a keyboard.

6. The optical touch sensor of claim 1, wherein the plurality of light emitting bare dies are light emitting diodes (LED).

7. The optical touch sensor of claim 1, wherein terminals of the plurality of light emitting bare dies are wire bonded to the first printed circuit board, and terminals of the plurality of light detecting bare dies are wire bonded to the second printed circuit board.

8. A method for forming an optical touch sensor, the method comprising:
attaching a plurality of bare optical dies to a printed circuit board;
connecting the plurality of bare optical dies to the printed circuit board through bond wires;
attaching a casing to the printed circuit board to form a pouch over the plurality of bare optical dies, the casing having a flat reflective surface positioned at a 45 degree angle to a surface of the printed circuit board; and
injecting an encapsulating material in the pouch to encapsulate the plurality of bare optical dies.

9. The method of claim 8, wherein the plurality of bare optical dies are bare light emitting diodes.

10. The method of claim 8, wherein the plurality of bare optical dies are bare light detecting diodes.

11. The method of claim 8, wherein the casing is made of a sheet stainless steel with the flat reflective surface being polished.

12. The method of claim 8, wherein the attaching the casing to the printed circuit board includes riveting the casing to the printed circuit board.

13. The method of claim 8, wherein the encapsulating material is substantially transparent to infrared light.
